(19) United States
(12) Patent Application Publication
(10) Pub. No.: US 2020/0296974 A1
(43) Pub. Date: Sep. 24, 2020

(54) CRISPER BAKING PAN

(71) Applicant: A2, Inc., Scarsdale, NY (US)

(72) Inventor: Louis Henry, Scarsdale, NY (US)

(21) Appl. No.: 16/825,677

(22) Filed: Mar. 20, 2020

Related U.S. Application Data
(60) Provisional application No. 62/821,279, filed on Mar. 20, 2019.

(51) Int. Cl. A21B 3/13

(52) U.S. Cl. CPC A21B 3/132

(57) ABSTRACT

The present disclosure provides a baking pan having a plurality of ribs projecting upward from the bottom surface thereof. The ribs and an outer wall of the pan define a plurality of cells. The ribs serve as a guide to a user pouring batter into the pan, to ensure that the batter is evenly poured in all areas of the pan. The batter can be poured to a point where it almost covers or just covers the top of the ribs. The present disclosure also provides a spatula having a flat shape at one end and a cutting wheel at another end.

### CROSS-REFERENCE TO RELATED APPLICATION

The present application claims the benefit of U.S. Provisional Patent Application Ser. No. 62/821,279, filed on Mar. 20, 2019, which is herein incorporated by reference in its entirety.

### BACKGROUND OF THE DISCLOSURE

### 1. Field of the Disclosure

The present disclosure provides a baking pan for making substantially evenly thick and crisp brownies, and a spatula with a cutting wheel. More particularly, the present disclosure provides a baking pan with ribs projecting up from the bottom to help guide how much batter should be used when filling the pan. The spatula has a flat portion on one end and a cutting wheel on an opposite end for ease of use.

### 2. Background of the Disclosure

With currently available baking pans, it can be difficult to ensure that the products that are cooked, for example brownies, are evenly sized or of the same height. When a user pours a batter into the pan, it can be very difficult to ensure that the batter is evenly spread out across the pan. Often there will be patches or areas of the pan that have less batter, leading to a shorter brownie. When brownies are of different sizes, they can be cooked unevenly and may also be cosmetically unpleasing.

There is a need to address these deficiencies.

### BRIEF SUMMARY OF THE DISCLOSURE

The baking pan of the present disclosure includes a raised outer edge around all sides that defines an interior space where batter for food products such as brownies can be poured. The pan is then inserted into an oven for baking. Advantageously, the bottom surface of the pan has raised protrusions or ribs that section areas of the bottom surface off into divided areas or cells. These ribs help guide the user when determining how much batter should be poured into the pan. The ribs are such that the batter can be poured to a height that either leaves a portion of the ribs showing through the batter, or where the tops of the ribs are just covered with batter. This helps to ensure that the batter is poured evenly throughout the entire interior space, which ensures substantially even cooking of the batter in each cell, as well as a substantially uniform thickness or height of each brownie. The height of the ribs also helps to guide the user in making thin, crispy brownies, which are pleasing to consumers aesthetically and for mouth feel, and wherein those brownies have a substantially even thickness. The ribs also score the underside of the brownie batter when it's cooked, leaving a crispy exterior of the brownie that is larger than with currently available pans. This also can be pleasing to the consumer.

The present disclosure also provides a spatula. Advantageously, the spatula of the present disclosure has a first end with a flat profile, and a second end with a cutting wheel connected thereto. The spatula has an ergonomic design so that the handle which connects the flat end and the wheel end can simply be rotated by a user's wrist to allow use of each end easily.

For sake of convenience, the term “brownie” is used to describe the food products that can be cooked in the baking pan of the present disclosure. However, the baking pan of the present disclosure can be used to cook any food product that is conducive to being poured or placed into a pan for cooking, such as other flour-based or bread products. Also, for sake of convenience, the term “ribs” is used to describe the protrusions or projections that rise from the bottom of the baking pan to divide the bottom into cells.

In one embodiment, the present disclosure provides a baking pan, including a bottom surface and a plurality of vertical walls adjacent to the bottom surface, so that the plurality of vertical walls and the bottom surface define an interior space. The pan also includes a plurality of ribs on the bottom surface, wherein the ribs project in a direction away from the bottom surface and into the interior space, and a plurality of cells defined by the plurality of ribs and/or the plurality of vertical walls, so that the cells have a depth. The baking pan holds food product to be cooked in the cells.

In another embodiment, the present disclosure provides a spatula comprising a first end, wherein the first end has a flat shape, a second end, wherein the second end has a cutting wheel connected thereto, and a handle, wherein the first end and the second end are connected via the handle.

### DESCRIPTION OF THE DRAWINGS

FIG. 1 is a top, perspective view of the baking pan and spatula of the present disclosure.

FIG. 2 shows a second top, perspective view of two of the baking pans of the present disclosure.

FIG. 3 shows a top view of two baking pans of the present disclosure, with the spatula of the present disclosure between them.

FIG. 4 shows a perspective view of the spatula of the present disclosure.

FIG. 5 shows a top, perspective view of the baking pan of the present disclosure.

FIG. 6 shows a top view of the baking pan of FIG. 5.

FIG. 7 shows a first side view of the baking ban of FIG. 5.

FIG. 8 shows a second side view of the baking pan of FIG. 5.

FIG. 9 shows a bottom view of the baking pan of FIG. 5.

FIG. 10 shows a top view of the baking ban of FIG. 5, with a cross-sectional line shown.

FIG. 10a shows a cross-section of the baking pan of FIG. 10, along section line B-B.

FIG. 10b shows a detail of area C in FIG. 10a.

FIG. 10c shows a detail of area D in FIG. 10a.

### DETAILED DESCRIPTION OF THE DISCLOSURE

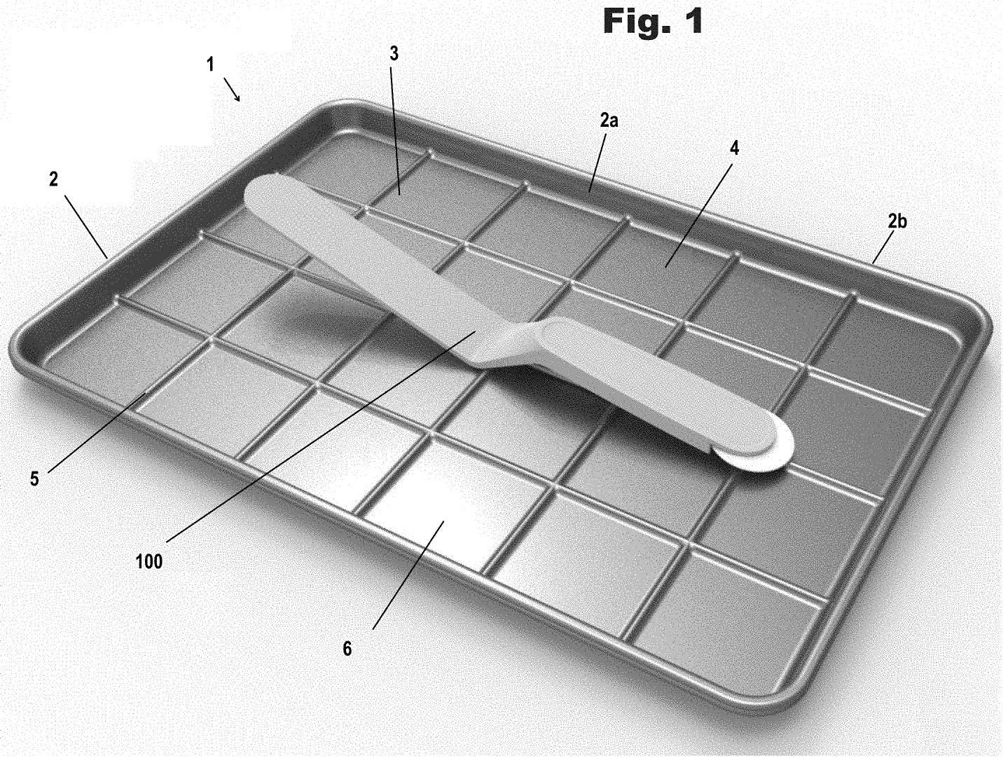

Referring to the drawings, and in particular FIG. 1, baking pan 1 is shown. Pan 1 has an outer wall 2 that defines an interior space 3. Outer wall 2 comprises a plurality of (e.g., four) upturned or substantially vertical walls 2a adjacent to bottom surface 4. The vertical walls 2a can be integral with one another and bottom surface 4. Outer wall 2 may have a rolled edge 2b. Bottom surface 4 has a plurality of ribs 5 that project upwards therefrom. Ribs 5 define a plurality of sections or cells 6. When a user pours a brownie mix or batter into pan 1, they can fill interior space 3 to the point that it leaves a top portion of ribs 5 exposed, or just covers them. In this way, ribs 5 help to provide a guide for the user, so the user can fill pan 1 evenly, to ensure even cooking and thickness of brownies. The height of ribs 5 is also such that the brownies will be relatively thin after baking, which helps to ensure a crisp texture. Without ribs 5, it would be difficult to ensure that an even layer of batter is spread throughout pan 1 or to monitor the height of the batter in pan 1.

Ribs 5 also project into the bottom of the batter as the batter cooks. When the brownies are ready, this provides an additional crispy surface on the brownie as compared to what is available in most pans, since ribs 5 leave a score mark on the underside of the brownies. When the brownies have been cooked, the user can simply turn pan 1 over onto a surface, letting the brownies fall onto that surface. The score marks make it easy for a user to separate or cut the brownies when they are cooked.

Pan 1 and ribs 5 are sized so that half of a standard package of brownie mix spreads out over all the cells 6 in pan 1, so that the height of the batter in each cell 6 is just below, at, or just above the height of ribs 5. That is, one standard package of brownie mix generally provides enough batter to fill two pans 1 of the present disclosure. A standard package of brownie mix typically produces two and one-third cups to two and one-half cups of uncooked batter.

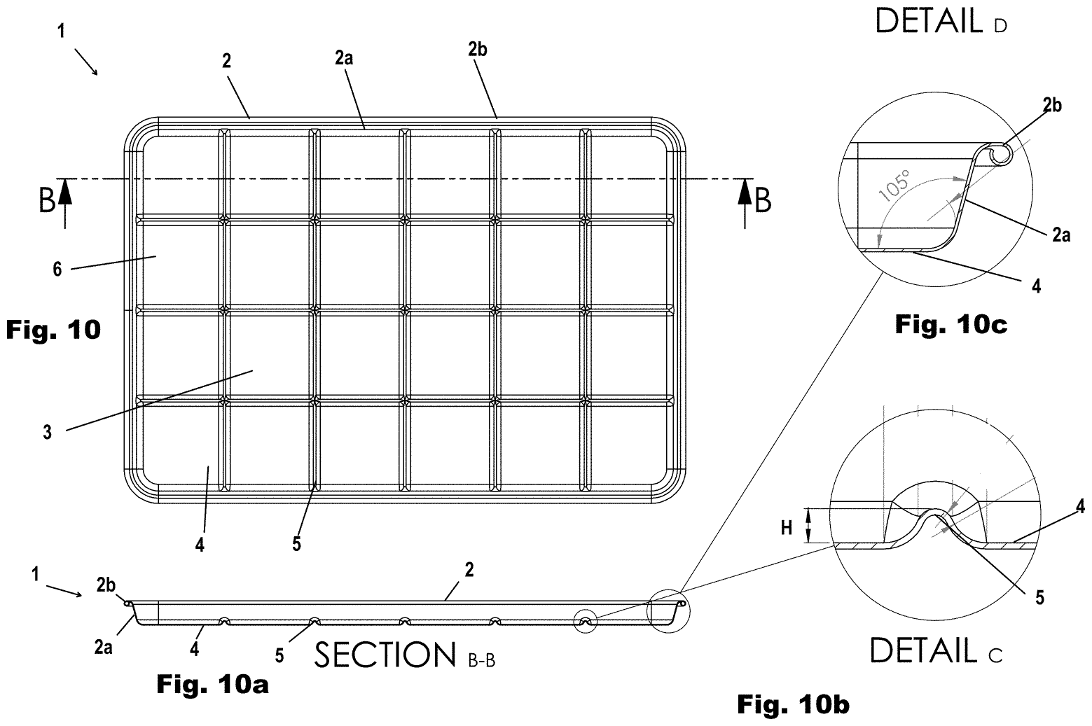

Referring specifically to FIGS. 10-10c, ribs 5 have a height H. In one embodiment, height H is from one millimeter to six millimeters, or any subranges therebetween. In another embodiment, height H is from two to four millimeters, or any subranges therebetween. The height of outer edge 2 is not critical, provided that it is higher than or the same height as the ribs. Height H of ribs 5 and the height of the outer edge is measured from the bottom surface 4 of pan 1 to the top of rib 5, as shown in the “Detail C” of FIG. 10b. Ribs 5 can have a rounded top and a bell-curve shape, as shown. Alternatively, ribs 5 can be squared off or rectangular in cross-section, or a very narrow spike or v-shape. Height H should be what is needed to achieve the effect described above, i.e. that when a certain amount of batter is poured into pan 1, it fills pan 1 to the point where the batter almost reaches or just covers the tops of ribs 5. This helps to even cooking of the brownies, and that they have a thin, crisp texture. The values for H provided earlier in this paragraph are particularly well-suited to achieving these objectives.

As shown in FIG. 10c, walls 2a are at an angle A with respect to bottom surface 4. Angle A may be ninety degrees, meaning that walls 2a would be perpendicular to bottom surface 4. Outer walls 2a may also be at an angle A greater than ninety degrees with respect to bottom surface 4, as shown.

As the batter within pan 1 cooks, it will rise. To remove the cooked batter, a user can flip the pan over. The brownies from each cell 6 will still be connected on the top side, but they will be scored on the bottom due to the ribs. The user can either break apart the brownies or use a cutter to separate them.

Pan 1 and ribs 5 can be formed as one, integral component. Alternatively, ribs 5 can be a separate component from pan 1, and can be connected to bottom surface 4, either removably or permanently. A “permanent” connection between two components is one in which the two components cannot be separated without destroying or damaging either one. The material used for pan 1 can be any food-safe material, such as suitable metals and silicone. Different metals will be easier to work with, depending on the shape and dimensions needed. Carbon steel or aluminum may be easier to work with regarding forming outer wall 2 and ribs 5. Stainless steel may also be used.

In the shown embodiment, pan 1 has an array of twenty-four cells 6, in a four-by-six arrangement. In the shown embodiment, cells 6 are square, and pan 1 is rectangular. Square or rectangular shapes are contemplated herein for pan 1 and cells 6 and may be preferred to ensure equal sizes of the brownies, but the present disclosure contemplates other shapes for pan 1 and cells 6, such as round or elliptical. Cells 6 may be the same size and shape or may have varying sizes within pan 1. The present disclosure also contemplates array sizes as small as one-by-two or two-by-two, up to as large as six-by-six, six-by-eight, eight-by-eight, or larger.

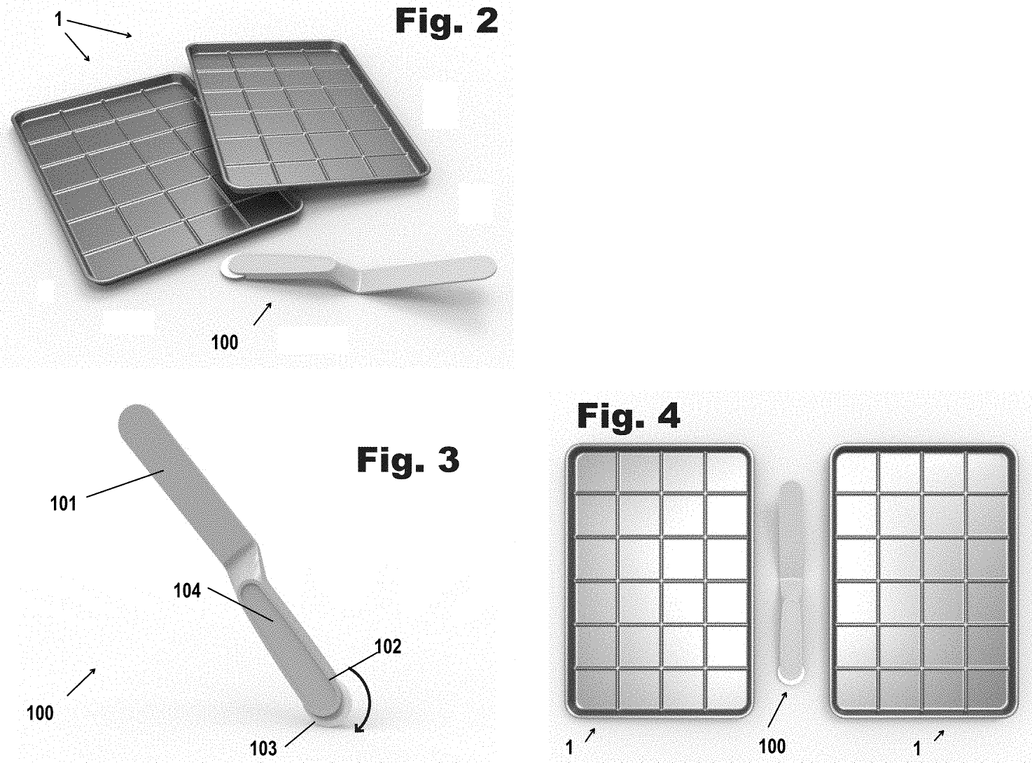

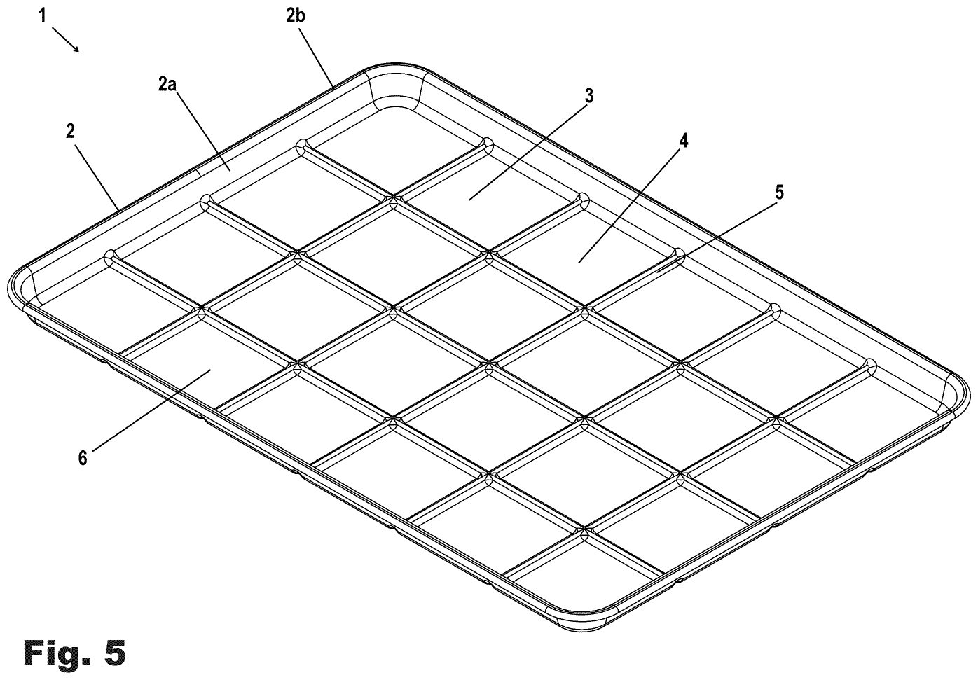

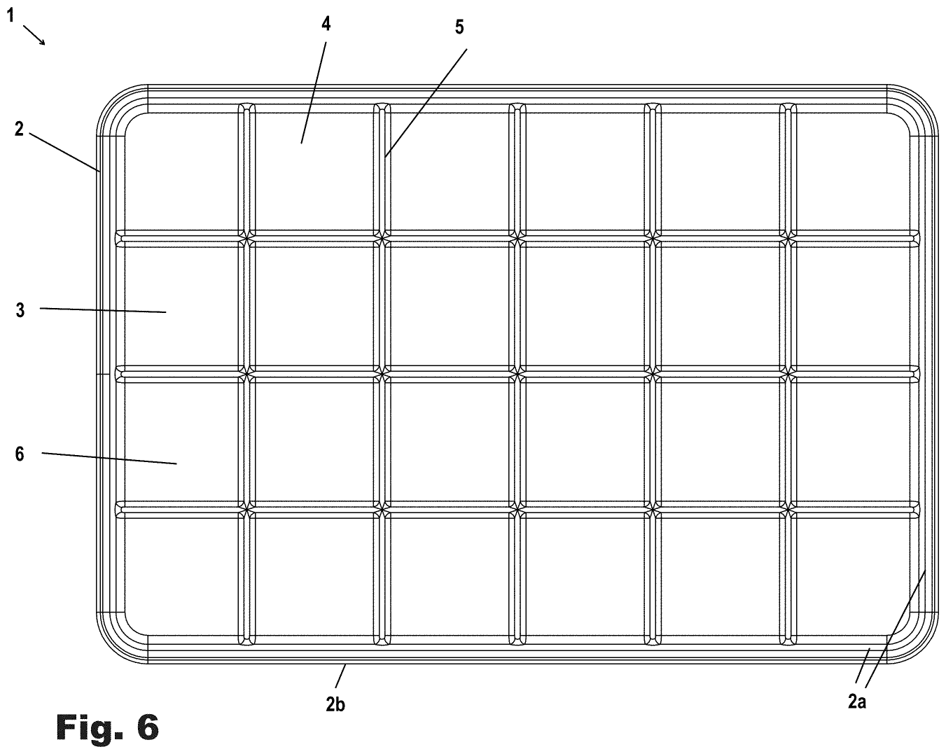

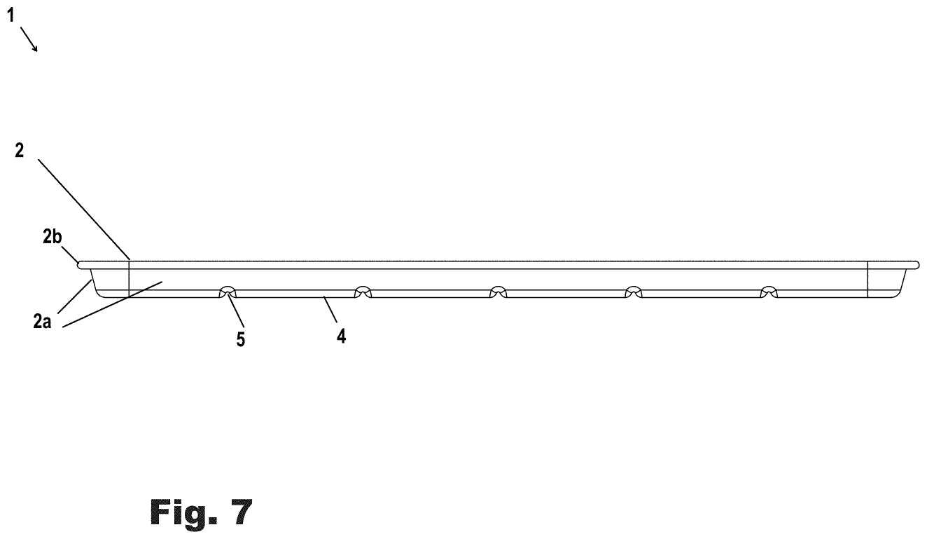

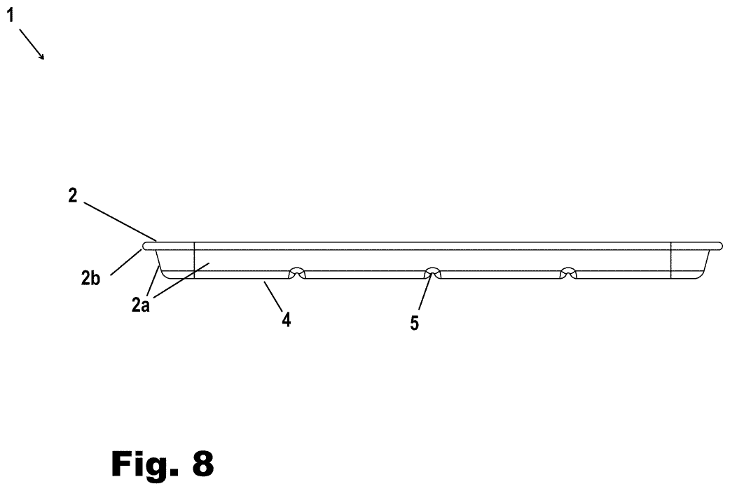

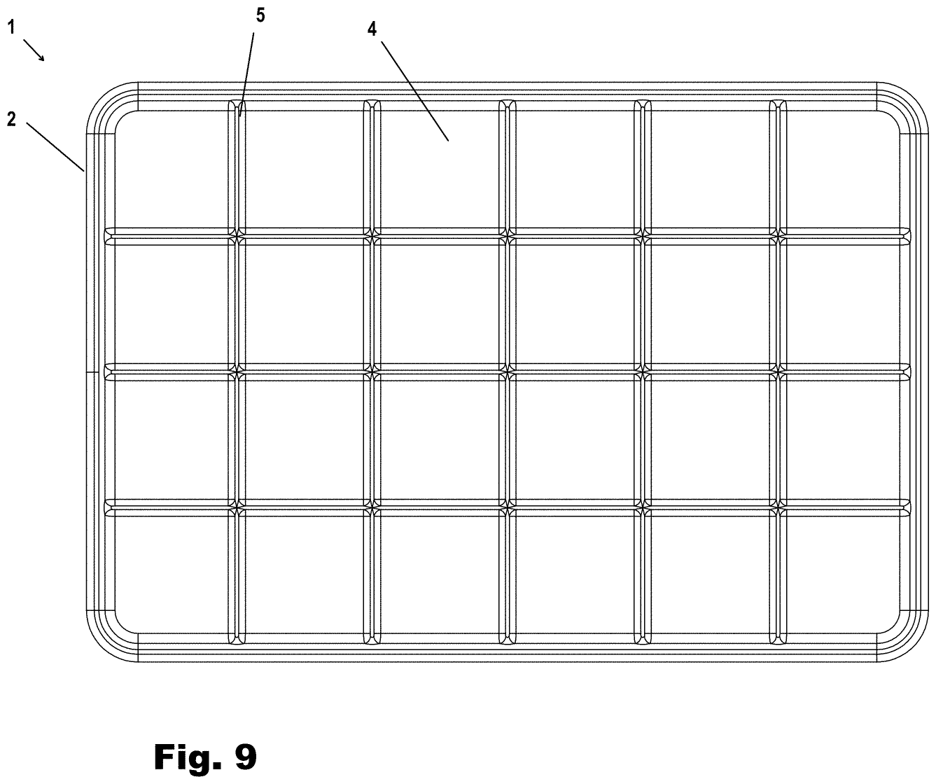

As shown in FIGS. 1-4, the present disclosure also provides a spatula 100. Spatula 100 has a flat end 101, a cutting wheel end 102 with a cutting wheel 103 connected thereto, and a handle 104 between flat end and wheel end 102. Flat end 101 is shaped like a spatula and can be used to lift foods off or surfaces. With spatula 100, a user can grip handle 104 and by rotating their wrist, easily switch between lifting food products with flat end 101, and cutting them with wheel end 102. Thus, spatula 100 of the present disclosure provides a simple, easy tool that combines a spatula and cutting wheel integrally, i.e. in one tool or component. Spatula 100 (including wheel 103) can be made entirely of plastic, or other food safe materials such as those described above with respect to pan 1. Spatula 100 and baking pan 1 can be packaged together or provided separately.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A baking pan, comprising:
a bottom surface;
a plurality of vertical walls adjacent to the bottom surface, so that the plurality of vertical walls and the bottom surface define an interior space;
a plurality of ribs on the bottom surface, wherein the ribs project in a direction away from the bottom surface and into the interior space; and
a plurality of cells defined by the plurality of ribs and/or the plurality of vertical walls, so that the cells have a depth,
wherein the baking pan holds food product to be cooked in the cells.

2. The baking pan of claim 1, wherein each of the plurality of ribs has a height of one millimeter to six millimeters.

3. The baking pan of claim 1, wherein each of the plurality of ribs has a height of two millimeters to four millimeters.

4. The baking pan of claim 1, wherein each of the plurality of ribs has a rounded top.

5. The baking pan of claim 1, wherein the plurality of ribs are a unitary component with the bottom surface of the baking pan.

6. The baking pan of claim 1, wherein the plurality of ribs are a separate component from the bottom surface of the baking pan, and are connected thereto.

7. The baking pan of claim 1, wherein each of the plurality of cells has a square or rectangular shape.

8. A spatula, comprising:
a first end, wherein the first end has a flat shape;
a second end, wherein the second end has a cutting wheel connected thereto; and
a handle, wherein the first end and the second end are connected via the handle.
